(19) United States
(12) Patent Application Publication
(10) Pub. No.: US 2023/0256990 A1
(43) Pub. Date: Aug. 17, 2023

(54) INFORMATION PROCESSING APPARATUS AND INFORMATION PROCESSING SYSTEM

(71) Applicant: TOYOTA JIDOSHA KABUSHIKI KAISHA, Toyota-shi Aichi-ken (JP)

(72) Inventors: Yu NAGATA, Chofu-shi Tokyo-to (JP); Yuki Fukaya, Okazaki-shi Aichi-ken (JP)

(73) Assignee: TOYOTA JIDOSHA KABUSHIKI KAISHA, Toyota-shi Aichi-ken (JP)

(21) Appl. No.: 18/108,168

(22) Filed: Feb. 10, 2023

(30) Foreign Application Priority Data
Feb. 15, 2022 (JP) 2022-021416

(51) Int. Cl. B60W 60/00; G06V 20/56

(52) U.S. Cl. CPC B60W 60/001; G06V 20/588; B60W 2552/53; B60W 2556/45

(57) ABSTRACT

An apparatus or system collects from a plurality of first vehicles first data relating to conditions of lane lines located in the neighborhood of the first vehicles, determines a first area in which the visibility of the lane lines is equal to or lower than a predetermined value on the basis of the first data, and performs specific processing to prevent entry of an autonomous vehicle into the first area. This can improve the safety of autonomous vehicles that perceive lane lens while travelling.

### CROSS REFERENCE TO THE RELATED APPLICATION

This application claims the benefit of Japanese Patent Application No. 2022-21416, filed on Feb. 15, 2022, which is hereby incorporated by reference herein in its entirety.

### BACKGROUND

### Technical Field

The present disclosure relates to an autonomous vehicle.

### Description of the Related Art

Various attempts have been made to popularize autonomous vehicles. In this connection, Patent Literature 1 in the citation list below discloses a system that searches for travel routes of autonomous vehicles taking into account risks in their travel.

### CITATION LIST

### Patent Literature

Patent Literature 1: Japanese Patent Application Laid-Open No. 2018-155577.

### SUMMARY

An object of this disclosure is to improve safety of travel of vehicles.

In a first aspect of the present disclosure, there is provided an information processing apparatus comprising a controller including at least one processor configured to execute the processing of collecting from a plurality of first vehicles first data relating to conditions of lane lines located in the neighborhood of the first vehicles determining a first area in which the visibility of the lane lines is equal to or lower than a predetermined value on the basis of the first data; and executing specific processing for preventing entry of an autonomous vehicle into the first area.

In a second aspect of the present disclosure, there is provided an information processing system comprising a server apparatus and a vehicle, wherein the vehicle comprises a first controller including at least one processor that transmits first data relating to conditions of lane lines located in the neighborhood of the vehicle to the server apparatus, and the server apparatus comprises a second controller including at least one processor that determines a first area in which the visibility of the lane lines is equal to or lower than a predetermined value on the basis of the first data and executes specific processing for preventing entry of an autonomous vehicle into the first area.

In other aspects of the present disclosure, there are also provided a method implemented by the above-described apparatus and a non-transitory storage medium in which a program configured to cause a computer to implement such a method is stored.

According to the present disclosure, it is possible to improve safety of travel of vehicles.

### BRIEF DESCRIPTION OF THE DRAWINGS

FIG. 1 is a diagram illustrating the general configuration of a vehicle system.

FIG. 2 is a diagram illustrating components of an on-vehicle apparatus 100.

FIG. 3 illustrates data created by the on-vehicle apparatus 100.

FIG. 4 is a diagram illustrating components of a server apparatus 200.

FIG. 5 illustrates the result of segmentation applied to an image.

FIG. 6A is a diagram illustrating successfully-recognized lane lines at a certain place.

FIG. 6B is a diagram illustrating an example of data recording the locations of lane lines in the corresponding road segment.

FIG. 7 illustrates changes in the visibility of lane lines.

FIG. 8 illustrates an example of a moving image database stored in the server apparatus.

FIG. 9 illustrates an example of lane line data stored in the server apparatus.

FIG. 10 illustrates an example of determination result data created by the server apparatus.

FIG. 11 is a flow chart of a process executed by the on-vehicle apparatus 100.

FIG. 12 is a flow chart of a process executed by the server apparatus 200.

FIG. 13A illustrates an example of calculation of an assessment value for a road segment.

FIG. 13B illustrates another example of calculation of an assessment value for a road segment.

FIG. 14 is a flow chart of a process executed by the server apparatus 200.

FIG. 15 is a flow chart of a process executed by an autonomous vehicle 300.

FIG. 16A illustrates an example of quick changes in the visibility.

FIG. 16B illustrates another example of quick changes in the visibility.

FIG. 17 is a flow chart of a process executed by the sever apparatus in a system according to a second embodiment.

### DESCRIPTION OF THE EMBODIMENTS

There are various techniques of assessing the safety of travel of an autonomous vehicle in advance. For example, there is a known system that determines a route which an autonomous vehicle is to travel (or should not travel) on the basis of the degree of risk in potential accidents and/or the incidence rate of accidents. The safety of travel of an autonomous vehicle can be assessed on the basis of, for example, properties of roads and traffic volume.

The safety of travel of an autonomous vehicle dynamically changes depending on road conditions. For example, in the case of a vehicle that perceives the traffic lane by a stereo-camera while travelling, safety travel is not possible under situations where lane lines are not visible (e.g. due to snow).

To improve the safety of travel of an autonomous vehicle, control of the operation takes into consideration dynamically-changing road conditions.

An information processing apparatus according to one aspect of this disclosure is characterized by including a controller configured to execute the processing of collecting, from a plurality of first vehicles, first data relating to conditions of lane lines located in the neighborhood of the first vehicles, determining a first area in which the visibility of the lane lines is equal to or lower than a predetermined value on the basis of the first data, and executing specific processing for preventing entry of an autonomous vehicle into the first area.

The lane lines are typically white (or yellow) lines that partition traffic lanes.

The controller in the information processing apparatus collects data relating to conditions of lane lines acquired by the first vehicles. Examples of such data include still and/or moving images captured by on-vehicle cameras and data representing results of recognition of lane lines. The first vehicles may be considered to be probe cars used to collect data.

The visibility of lane lines can change with deterioration over time or depending on the weather (e.g. snow). If the visibility of lane lines is lowered, there is a possibility that autonomous vehicles cannot recognize lane lines correctly, which can lead to deterioration of safety of travel.

To address this problem, the information processing apparatus disclosed herein determines a first area in which the visibility of lane lines is equal to or lower than a predetermined value and prevents autonomous vehicles from entering the first area.

The first area may be expressed by a set of road links or road segments or a set of a plurality of pieces of location information.

For example, if the information processing apparatus is an apparatus that provides route information to an autonomous vehicle, it may create routes keeping out of the first area. If the information processing apparatus is an apparatus that controls the operation of an autonomous vehicle, it may instruct the autonomous vehicle not to enter the first area. Alternatively, the information processing apparatus may instruct the autonomous vehicle to make a detour around the first area. Still alternatively, the information processing apparatus may suspend the operation of the autonomous vehicle, if the autonomous vehicle is planned to pass the first area.

With the above configuration, the information processing apparatus can determine the road condition on the basis of data collected by the probe cars and optimize the operation of the autonomous vehicle.

The controller may assess the visibility of lane lines by analyzing a vehicle-view moving image (defined below) sent from a first vehicle. For example, the visibility of lane lines can be determined by comparing the location of a lane line detected from the vehicle-view moving image and the location of the lane line defined in a database. The vehicle-view moving image mentioned above is a moving image captured by an on-vehicle camera.

The visibility of lane lines may be determined on the basis of a plurality of pieces of first data accumulated over a specific period in the past. This can improve the accuracy of determination.

However, the method of determination using the first data accumulated in the past cannot handle cases where the visibility of lane lines changes quickly. To address this problem, the controller may be configured to determine changes of the visibility of lane lines over time. For example, if the visibility of lane lines changes quickly in a certain place, the controller may exclude the first data acquired before the change in determining the first area.

Specific embodiments of the technology disclosed herein will be described with reference to the drawings. It should be understood that the hardware configuration, the module configuration, the functional configuration and other features that will be described in connection with the embodiments and their modification are not intended to limit the technical scope of the disclosure only to them, unless stated otherwise.

### First Embodiment

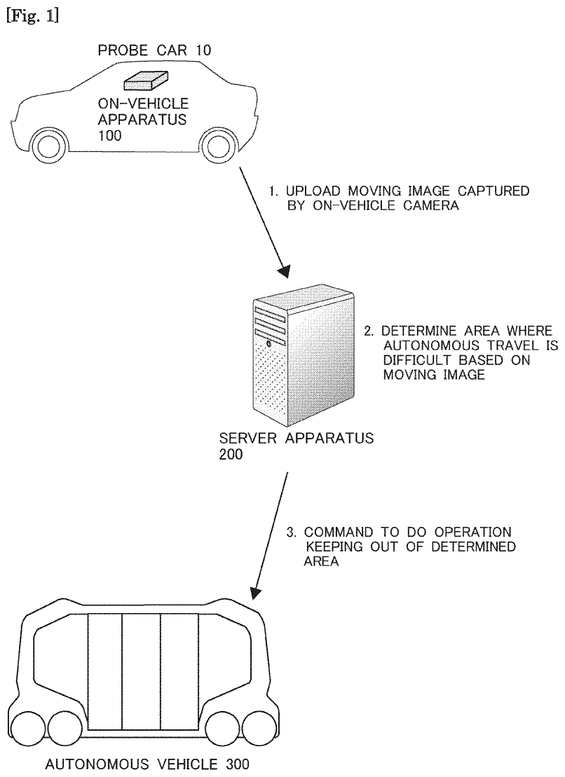

A vehicle system according to a first embodiment will be described with reference to FIG. 1.

The vehicle system according to the embodiment includes probe cars 10, a server apparatus 200, and autonomous vehicles 300.

The probe car 10 is a vehicle used to collect data. The probe car 10 may be either an autonomous vehicle or a vehicle driven by a human driver. The probe car 10 may be an ordinary vehicle that is configured to provide data under contract with a service provider.

The autonomous vehicle 300 is an autonomously-driven vehicle that provides a certain service. The autonomous vehicle 300 may be a vehicle that transports passengers or goods or a mobile shop vehicle. The autonomous vehicle 300 can travel and provide a service according to a command sent from the server apparatus 200.

The server apparatus 200 is an apparatus that controls the operation of the autonomous vehicle 300. The server apparatus 200 determines an area that is inappropriate for the autonomous vehicle 300 to travel and keeps the autonomous vehicle 300 out of that area during its operation.

In the following, elements included in the system will be described. The probe car 10 is a connected car having the function of communicating with an external network. The probe car 10 is provided with an on-vehicle apparatus 100.

The on-vehicle apparatus 100 is a computer used to collect information. The on-vehicle apparatus 100 in the system of this embodiment is provided with a camera oriented to the front direction of the vehicle. The on-vehicle apparatus 100 sends a moving image captured by the camera to the server apparatus 200 at predetermined point of time. In the following, the moving image captured by the on-vehicle apparatus 100 will be referred to as the vehicle-view moving image hereinafter.

The on-vehicle apparatus 100 may be an apparatus that provides information to the driver or occupants of the probe car 10 (e.g. a car navigation apparatus) or an electronic control unit (ECU) provided in the probe car 10. Alternatively, the on-vehicle apparatus 100 may be a data communication module (DCM) having a communication function.

The on-vehicle apparatus 100 may be constituted by a general-purpose computer. Specifically, the on-vehicle apparatus 100 may be constructed as a computer provided with a processor, such as a CPU and/or a GPU, a main storage device, such as a RAM and/or a ROM, and an auxiliary storage device, such as an EPROM, a hard disk drive, and/or a removable medium. In the auxiliary storage device are stored an operating system (OS), various programs, and various tables. Various functions for achieving desired purposes that will be described later can be implemented by executing programs stored in the auxiliary storage device. Some or all of such functions may be implemented by a hardware circuit(s), such as an ASIC(s) and/or an FPGA(s).

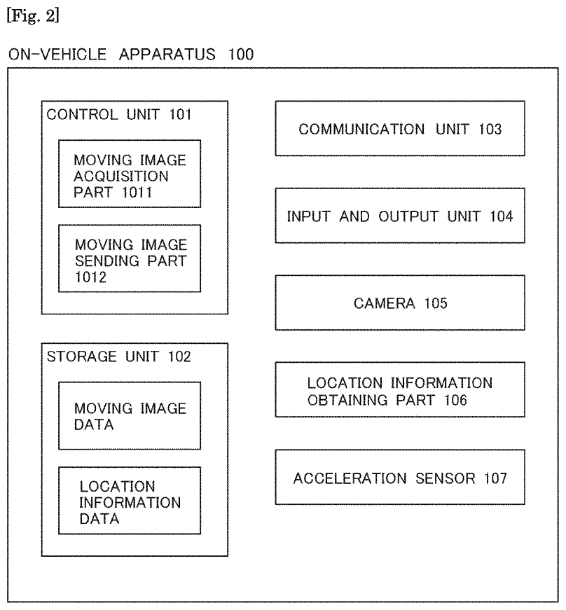

FIG. 2 is a diagram illustrating the system configuration of the on-vehicle apparatus 100.

The on-vehicle apparatus 100 includes a control unit 101, a storage unit 102, a communication unit 103, an input and output unit 104, a camera 105, a location information obtaining unit 106, and an acceleration sensor 107.

The control unit 101 is a computational unit that executes programs to implement various functions of the on-vehicle apparatus 100. The control unit 101 may be constituted by, for example, a CPU.

The control unit 101 has, as functional modules, a moving image acquisition part 1011 and a moving image sending part 1012. These functional modules may be implemented by execution of stored programs by the CPU.

The moving image acquisition part 1011 captures moving images by the camera 105, which will be described later, and stores the captured images in the storage unit 102. When the system power of the vehicle is turned on, the moving image acquisition part 1011 creates a new storage area (e.g. a folder or a directory). Created data is stored in this storage area until the system power of the vehicle is turned off.

While the on-vehicle apparatus 100 is on, the moving image acquisition part 1011 captures moving images by the camera 105 and stores the acquired data (i.e. moving image data) in the storage unit 102. The moving image data is stored as files. The length (or duration) of the moving image of one file is limited (e.g. one or five minutes etc.), and a new file is created when the length exceeds the limit. If the storage capacity becomes insufficient, the moving image acquisition part 1011 deletes the oldest file to create an available space and continues image capturing.

The moving image acquisition part 1011 obtains location information of the vehicle through the location information obtaining unit 106, which will be described later, at predetermined intervals (e.g. at intervals of one second), and stores it as location information data.

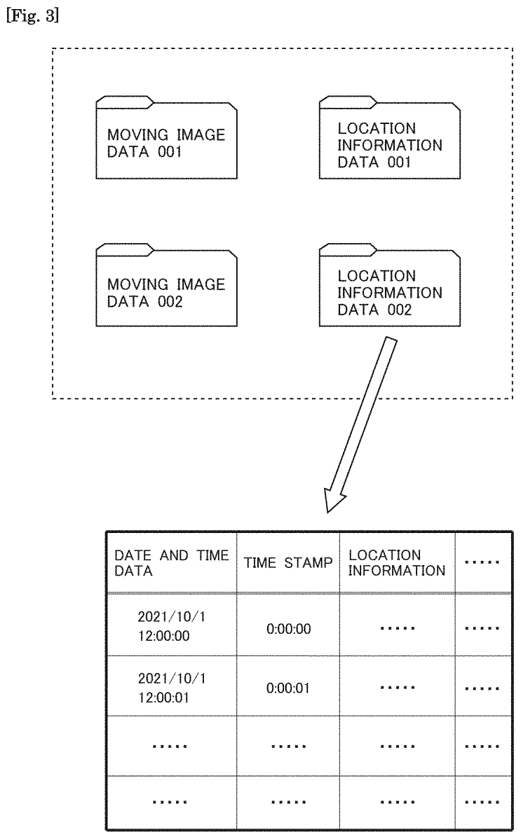

FIG. 3 is a diagram schematically illustrating the moving image data and the location information data stored in the storage unit 102. As illustrated in FIG. 3, pieces (e.g. files) of moving image data and pieces of location information data are in one to one correspondence with each other. As the pieces of moving image data and the pieces of location information data are stored in a linked manner, it is possible to determine the location of the travelling vehicle at a later time.

The moving image sending part 1021 sends the moving image data stored in the storage unit 102 to the server apparatus 200 at predetermined points of time. The predetermined points of times may be periodic times. For example, the moving image sending part 1012 may send moving image data recorded in the latest file to the server apparatus 200 at the time when the next file is newly created.

The storage unit 102 is a memory device including a main storage device and an auxiliary storage device. In the auxiliary storage device are stored an operating system (OS), various programs, and various tables. The programs stored in the auxiliary storage device are loaded into the main storage device and executed to implement functions for achieving desired purposes.

The main storage device may include a RAM (Random Access Memory) and/or a ROM (Read Only Memory). The auxiliary storage device may include an EPROM (Erasable Programmable ROM) and/or a hard disk drive (HDD). The auxiliary storage device may include a removable medium, or a portable recording medium.

In the storage unit 102 is stored data created by the control unit 101, which includes the moving image data and the location information data.

The communication unit 103 is a wireless communication interface that connects the on-vehicle apparatus 100 to the network. The communication unit 103 is capable of communicating with the server apparatus 200 using a communication scheme, such as a mobile communication network, wireless LAN, or Bluetooth (registered trademark).

The input and output unit 104 is a unit that receives input operations performed by a user and provides information to the user. The input and output unit 104 includes, for example, a liquid crystal display, a touch panel display, and/or hardware switches.

The camera 105 is an optical unit including an image sensor that captures images.

The location information obtaining part 106 creates location information by computation based on positioning signals sent from positioning satellites (also called GNSS satellites). The location information obtaining part 106 may include an antenna that receives radio waves sent from the GNSS satellites.

The acceleration sensor 107 is a sensor that measures the acceleration acting on the apparatus. The result of measurement is supplied to the control unit 101. Thus, the control unit 101 can determine impacts acting on the vehicle.

Next, the server apparatus 200 will be described.

The server apparatus 200 is an apparatus that controls the operation of the autonomous vehicle 300. The server apparatus 200 also has the function of determining an area which autonomous vehicles should not enter on the basis of moving image data collected from a plurality of probe cars 10 (or on-vehicle apparatuses 100).

In the following description, an area which autonomous vehicles should not enter will be referred to as “inappropriate area”. The process of determining an inappropriate area on the basis of moving image data will be referred to as “first process”. The process of controlling the operation of an autonomous vehicle in such a way as to keep them out of the inappropriate area will be referred to as “second process”.

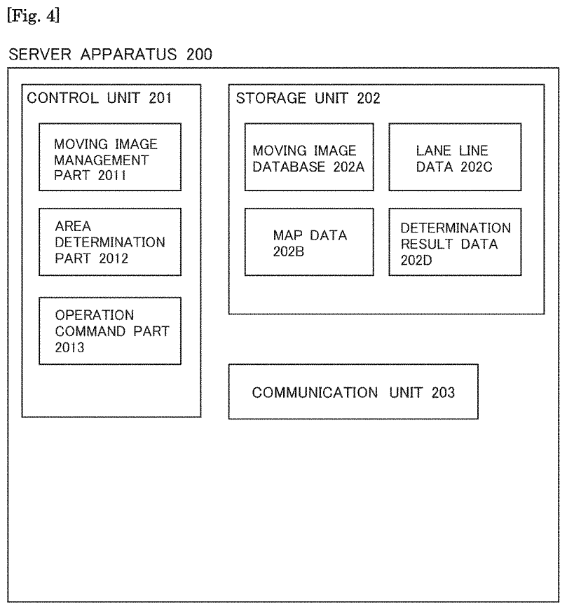

FIG. 4 is a diagram specifically illustrating components of the server apparatus 200 included in the vehicle system according to the embodiment.

The server apparatus 200 may be constituted by a general-purpose computer. Specifically, the server apparatus 200 may be constructed as a computer provided with a processor, such as a CPU and/or a GPU, a main storage device, such as a RAM and/or a ROM, and an auxiliary storage device, such as an EPROM, a hard disk drive, and/or a removable medium. In the auxiliary storage device are stored an operating system (OS), various programs, and various tables. The programs stored in the auxiliary storage device are loaded into a working space in the main storage device and executed to thereby control various components. In this way, the server apparatus 200 can implement functions for achieving desired purposes that will be describe later. Some or all of such functions may be implemented by a hardware circuit(s), such as an ASIC(s) and/or an FPGA(s).

The server apparatus 200 includes a control unit 201, a storage unit 202, and a communication unit 203.

The control unit 201 is a computational device that executes control processing performed by the server apparatus 200. The control unit 201 may be constituted by a computational device, such as a CPU.

The control unit 201 includes, as functional modules, a moving image management part 2011, an area determination part 2012, and an operation command part 2013. These functional modules may be implemented by executing programs stored in the storage unit by a CPU.

The moving image management part 2011 executes the processing of collecting moving image data sent from a plurality of probe cars 10 (or on-vehicle apparatuses 100) and storing the moving image data in the storage unit 202 (moving image database 202A), which will be specifically described later.

The area determination part 2012 determines inappropriate areas, namely areas that the autonomous vehicles should not enter, on the basis of the collected moving image data.

Here, the area that autonomous vehicles should not enter will be specifically described. The autonomous vehicle 300 in the system of this embodiment is a vehicle that is configured to recognize the position of the traffic lane on the basis of images captured by a stereo camera while travelling. The position of the traffic lane can be determined by optically perceiving lane lines.

The visibility of lane lines may be lowered by deterioration over time. The visibility of lane lines may also be lowered due to weather or environmental causes (e.g. snow, wind and rain, or a light source behind), besides deterioration over time. If the visibility of lane lines is lowered, it is difficult for autonomous vehicles to travel safely, and there may be cases where autonomous vehicles cannot continue travelling.

To address the above problem, the area determination part 2012 in the system of this embodiment executes the processing of assessing the visibility of lane lines on the basis of the moving image data collected by a plurality of probe cars 10 and determining an area in which the visibility of lane lines is low.

The area determination part 2012 firstly recognizes the presence of lane lines on the basis of the moving image data and creates data representing the visibility of the lane lines.

The presence of lane lines can be recognized, for example, using segmentation technique. The segmentation technique is a technique of segmenting objects contained in an image into a plurality of classes. This is mainly achieved by a machine learning model. By performing such segmentation, objects contained in an image can be labelled as, for example, “sky”, “nature”, “other vehicle”, “building”, “lane line”, “road”, and “host vehicle”.

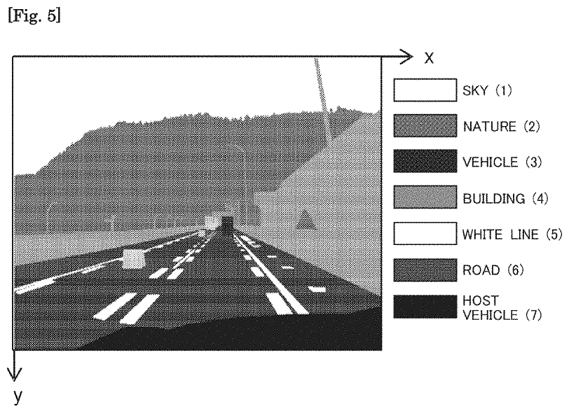

FIG. 5 is an exemplary labelled image in which objects are labelled by segmentations.

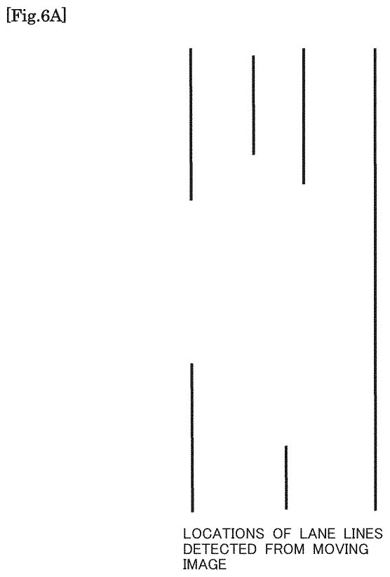

Moreover, it is possible to create a plan view (or map) of the lane lines that are successfully recognized by converting the labelled image. FIG. 6A is a plan view illustrating successfully-recognized lane lines at a certain place. FIG. 6A illustrates a case where some lane lines are partly missing, which means that the apparatus cannot recognize the presence of the missing portions of the lane lines.

Secondly, the area determination part 2012 consults a database in which the locations of lane lines are recorded to compare the result of recognition of lane lines and data recorded in the database. FIG. 6B illustrates an example of data recording the locations of lane lines in the corresponding road segment. Such data is stored in the storage unit 202, which will be specifically described later. The area determination part 2012 can determine portions of the lane lines whose visibility is low by comparing the two kinds of data. Specifically, for example, the area determination part 2012 determines the degree of agreement of the lane lines recognized from an image of a specific frame in a moving image with the lane lines recorded in the database. This degree of agreement serves as a value representing the visibility of the lane lines. This value will be hereinafter referred to as the “degree of visibility”. The degree of visibility is represented, for example, by points between 1 and 100.

The area determination part 2012 performs this determination at intervals of a predetermined number of frames of the vehicle-view moving image (e.g. at intervals of one second or five seconds).

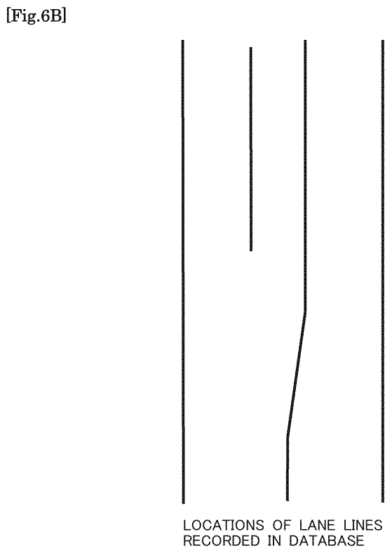

FIG. 7 is a graph indicating exemplary plots of degree of visibility (e.g. the degree of visibility calculated at intervals of ten seconds), which changes with time. In this exemplary case indicated in FIG. 7, the section designated by reference numeral “701” may be determined as a section in which the visibility of lane lines is low.

The area determination part 2012 updates determination result data 202D, which will be described later, with the result of determination.

The area determination part 2012 determines an inappropriate area on the basis of the determination result data 202D. This area is not necessarily a closed space. For example, the inappropriate area may be a set of road segments including a location or place where the aforementioned degree of visibility is lower than a predetermined threshold. If a certain road link includes even one such road segment, the area determination part 2012 may determine that autonomous vehicles should not enter this road link.

Information about the inappropriate area created by the area determination part 2012 is sent to the operation command part 2013.

The operation command part 2013 creates an operation plan for a specific autonomous vehicle 300 and sends the created operation plan to this vehicle 300.

The operation plan is data that gives to the autonomous vehicle 300 instructions for tasks to be fulfilled. In the case where the autonomous vehicle 300 is a vehicle for transporting passengers, the tasks to be fulfilled include the tasks of picking up and dropping off passengers and the task of traveling to a designated place. In the case where the autonomous vehicle 300 is a vehicle for transporting goods (or packages of goods), the tasks to be fulfilled include the task of receiving goods, the task of travelling to a designated place, and the task of delivering the goods. In the case where the autonomous vehicle 300 is a mobile shop, the tasks to be fulfilled include the task of travelling to a designated place, and the task of opening the shop at that place.

The operation command part 2013 creates an operation plan as a set of plurality of tasks, and the autonomous vehicle 300 fulfils the tasks sequentially according to the operation plan to provide a specific service.

The storage unit 202 includes a main storage device and an auxiliary storage device. The main storage device is a memory in which programs executed by the control unit 201 and data used by the control programs are loaded and resident. The auxiliary storage device is a device in which the programs executed by the control unit 201 and data used by the control programs are stored.

What is stored in the storage unit 202 includes a moving image database 202A, map data 202B, lane line data 202C, and determination result data 202D.

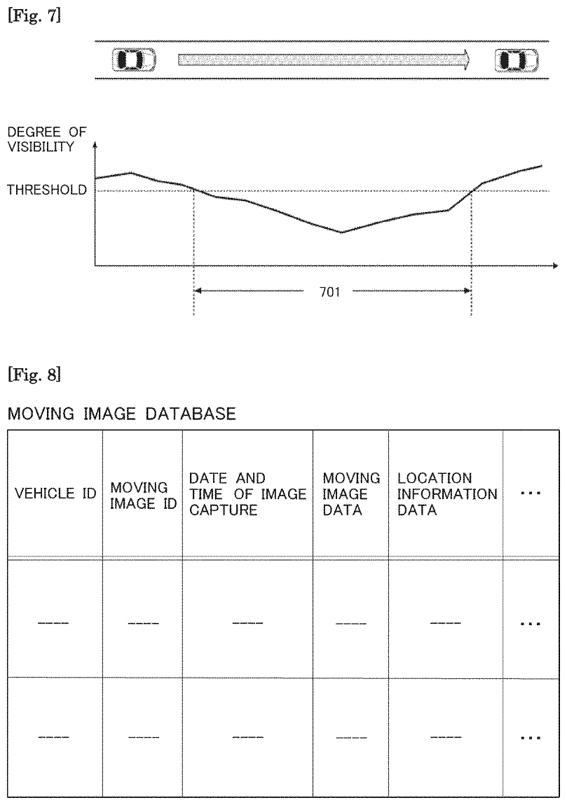

The moving image database 202A is a database in which a plurality of pieces of moving image data sent from the on-vehicle apparatuses 100 are stored. FIG. 8 illustrates an example of data stored in the moving image database 202A. As illustrated, what is stored in the moving image database 202A includes identifiers of vehicles that have sent moving image data, identifiers of moving image data, date and time of image capture, moving image data, and location information data of probe cars. The moving image data stored in the moving image database may be deleted at a certain point of time (e.g. at the time when a predetermined time has elapsed since the reception of data).

The map data 202B is a database in which a road map is stored. The road map can be expressed by, for example, a set of nodes and links. The map data 202B includes definitions of nodes, links, and road segments included in the links. The road segment refers to a unit section formed by segmenting a road link into a specific length of section. Each road segment may be liked with location information (latitude and longitude), an address, a place name, and/or a road name.

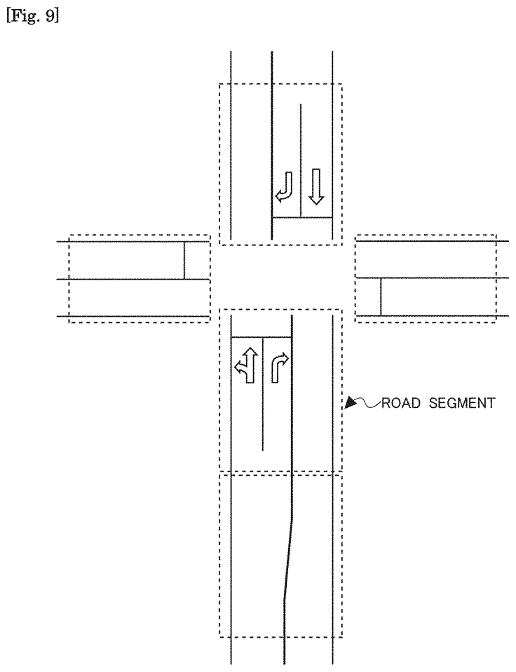

The lane line data 202C is data that defines information about the locations of the lane lines in each of the road segments. FIG. 9 is a diagram illustrating the lane lines included in road segments. The lane line data 202C records location information of the lane lines in each of the road segments.

The determination result data 202D is data that records the result of determinations made by the area determination part 2012. As described above, the area determination part 2012 calculates the degree of visibility of lane lines at predetermined timing and records the result of the determination together with location information of the probe car.

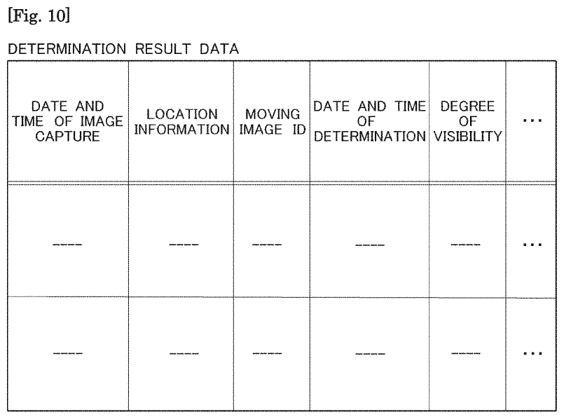

The determination result data 202D may be, for example, data of the location information and the degree of visibility linked with each other. FIG. 10 illustrates an example of the determination result data 202D.

In the illustrative case indicated in FIG. 10, the determination result data 202D has the fields of date and time of image capture, location information, moving image ID, date and time of determination, and degree of visibility.

What is stored in the field of date and time of image capture is information about the date and time when the moving image used in the determination of the degree of visibility was captured. What is stored in the field of location information is the location information (latitude and longitude) of the probe car 10. What is stored in the field of moving image ID is an identifier of the moving image used in the determination of the degree of visibility. What is stored in the field of date and time of determination is information about the date and time when the determination of the degree of visibility was performed, and what is stored in the field of degree of visibility is the degree of visibility expressed by a numerical value that is obtained as the result of the determination.

While in the illustrated case location information of the probe car 10 and the degree of visibility are linked and stored every time the determination is performed, the degree of visibility may be lined with a road segment or a road link. For example, in cases where the determination of the degree of visibility is performed multiple times for the same road segment or road link, a representative value of the multiple times of determination may be linked with the road segment or the road link and stored. The determination result data 202D may be any form of data, so long as it enables determination of a place, road segment, road link, or area in which the degree of visibility is lower than a predetermined value.

The communication unit 203 is a communication interface used to connect the server apparatus 200 to a network. The communication unit 203 includes, for example, a network interface board and a wireless communication interface for wireless communication.

The configurations illustrated in FIGS. 2 and 4 are exemplary configurations. Some or all of the functions indicated in FIGS. 2 and 4 may be implemented using a purpose-built circuit(s). A main storage device and an auxiliary storage device that are different from those indicated in the drawings may be employed to store and execute programs.

Next, details of processes executed by the apparatuses included in the vehicle system will be described.

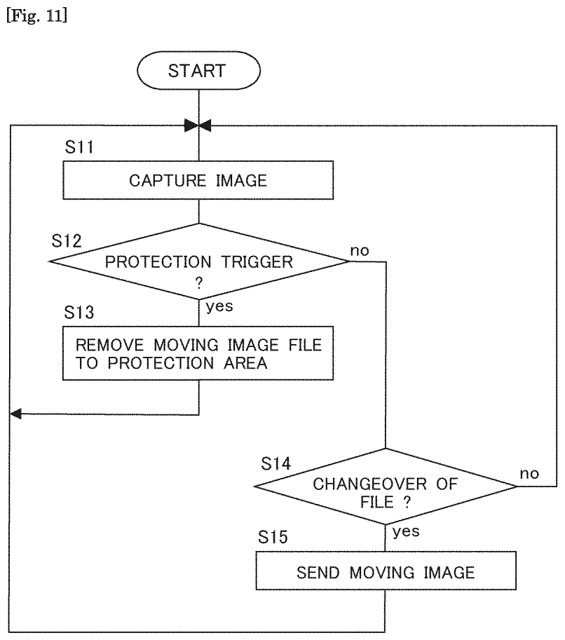

FIG. 11 is a flow chart of a process executed by the on-vehicle apparatus 100. The process according to the flow chart of FIG. 11 is executed repeatedly by the control unit 101 while the on-vehicle apparatus 100 is on.

In step S11, the moving image acquisition part 1011 captures a moving image with the camera 105. In this step, the moving image acquisition part 1011 records an image signal output from the camera 105 in a file as moving image data. As previously described with reference to FIG. 3, the file is divided every predetermined length (or duration). When the storage capacity of the storage unit 102 is not sufficient, files are overwritten in order from the oldest one. In this step, the moving image acquisition part 1011 obtains location information periodically through the location information obtaining unit 106 and records the obtained location information in the location information data (see FIG. 3).

In step S12, the moving image acquisition part 1011 determines whether or not a protection trigger is generated. The protection trigger is generated, for example, when an impact is detected by the acceleration sensor 107 or a save button provided on the body of the apparatus is pressed by the user. Then, the process proceeds to step S13, where the moving image acquisition part 1011 removes the file presently being recorded to a protection area. The protection area is an area where automatic overwriting of files will not be performed. Thus, files in which important scenes are recorded are protected. If the protection trigger is not generated, the process returns to step S11, and image-capturing is continued.

If the protection trigger is not generated, the process proceeds to step S14, where it is determined whether or not a changeover of files has occurred. As described previously, a limit is set for the length (or duration) of a moving image of one file (e.g. one or five minutes), and if the limit is exceeded, a new file is created. If a changeover has occurred, the process proceeds to step S15. If a changeover has not occurred, the process returns to step S11.

In step S15, the moving image sending part 1012 sends the moving image data to the server apparatus 200 together with location information data. The server apparatus 200 (specifically, the moving image management part 2011) stores the received data in the moving image database 202A.

Next, details of a process executed by the server apparatus 200 will be described.

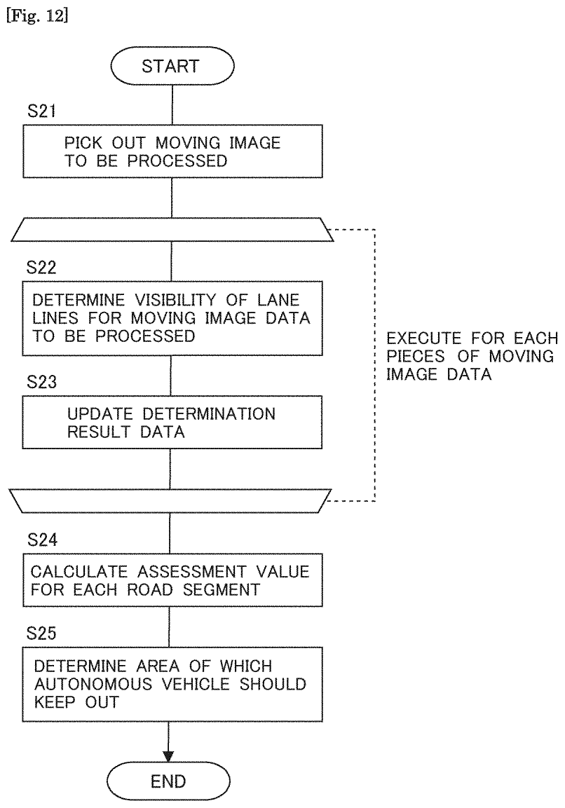

FIG. 12 is a flow chart of the first process executed by the server apparatus 200, namely the process of determining an inappropriate area on the basis of moving image data. This process is executed by the area determination part 2012 at a predetermined time after moving image data has been accumulated.

Firstly, in step S21, the area determination part 2012 retrieves one or more pieces of moving image data to be processed from the moving image database 202A. The moving image data to be processed may be one for which a determination as to lane lines has never been performed.

The processing of steps S22 and S23 is executed for each of the pieces of moving image data retrieved in step S21.

In step S22, the area determination part 2012 performs a determination as to the visibility of lane lines for the moving image data to be processed. For example, the area determination part 2012 calculates the degree of visibility of lane lines at intervals of a predetermined number of frames, as described previously with reference to FIG. 7, to create the determination result data indicated in FIG. 10. Since the moving image data contains location information of the probe car 10, it is possible in step S22 to create data of the location of the probe car 10 and the degree of visibility linked with each other. Then, in step S23, the area determination part 2012 updates the determination result data 202D with the data created in step S22, in other words, adds the created data to the determination result data 202D as a new record.

In step S24, the area determination part 2012 calculates an assessment value of each road segment on the basis of the determination result data 202D.

Every time the determination as to the visibility of lane lines is performed, its record is added to the determination result data 202D. In step S24, the area determination part 2012 determines an assessment value for each of the road segments using all the data recorded in the determination result data 202D. For example, if the determination result data 202D contains a plurality of records of determination performed for a certain road segment, the area determination part 2012 calculates a representative value of the plurality of degrees of visibility and uses the representative value as the assessment value for that road segment.

While in this illustrative case all the data recorded in the determination result data 202D is used in calculating the assessment value, data that matches a certain condition may be excluded. For example, vehicle-view moving images older than a certain period of time (e.g. one month, one week, or one day) may be excluded, because the usefulness of such moving images may be low. In other words, the assessment value may be calculated using only data created during a predetermined period of time in the past.

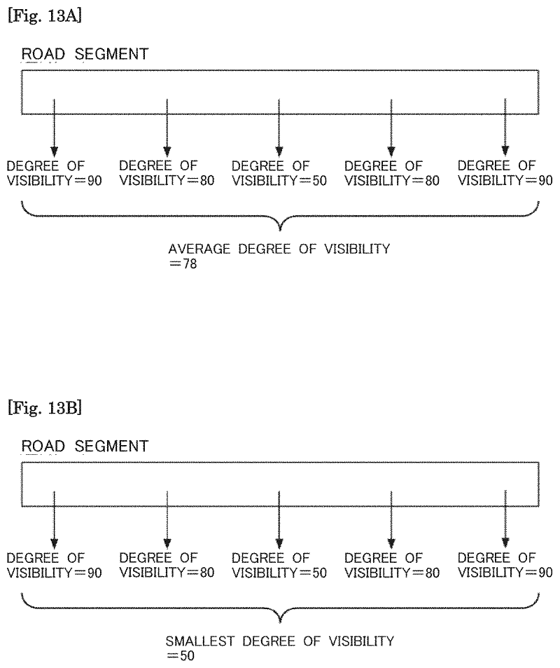

FIG. 13A illustrates an exemplary case where five times of determination have been performed for a certain road segment. If the representative value is calculated as the average of the plurality of degrees of visibility, the representative value for this road segment is 78 points.

Alternatively, the smallest value of the degree of visibility may be used as the assessment value. In other words, the lowest degree of visibility among a plurality of locations in the road segment may be used as the representative value. FIG. 13B illustrates a case where the smallest value of the plurality of degrees of visibility is used as the representative value. In this case, the assessment value for this road segment is 50 points.

The assessment value for a road segment may be calculated as a weighted average. Weighting in calculating a weighted average may be determined based on the date and time of capturing of vehicle-view moving images. For example, the smaller the number of days having passed since the date of image capturing is, the larger the weight to be given may be made. In contrast, the older the time of image capturing is, the smaller the weight may be made.

In this step a map in which assessment values are assigned to respective road segments may be created.

In step S25, an inappropriate area is determined on the basis of the assessment values calculated for the respective road segments. An inappropriate area may be either a set of one or more road segments or a closed space. For example, the area determination part 2012 determines an area that includes at least one road segment for which the assessment value is equal to or smaller than a predetermined value or an area that includes only road segments for which the assessment values are equal to or smaller than the predetermined value as an inappropriate area.

Next, a process executed by the server apparatus 200 to give instructions for operation to the autonomous vehicle 300 will be described.

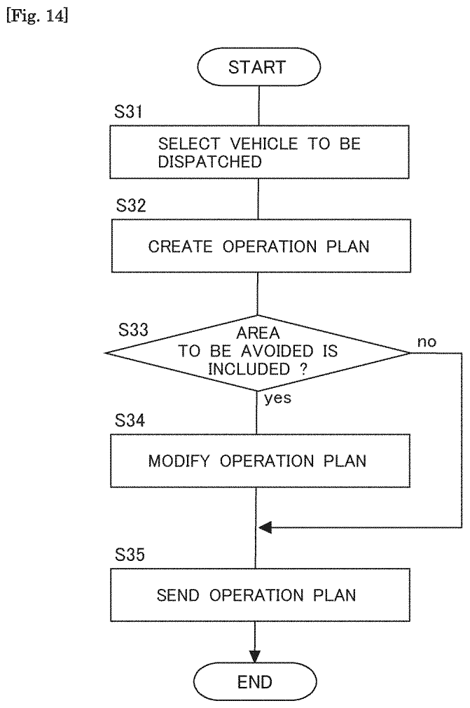

FIG. 14 is a flow chart of the second process executed by the server apparatus 200, namely the process of giving instructions for operation to an autonomous vehicle 300. The process according to the flow chart of FIG. 14 is executed by the operation command part 2013 when a trigger for dispatching an autonomous vehicle 300 is generated. For example, in the case where a transportation service is to be provided by an autonomous vehicle, this process is started when a request for dispatch of a vehicle is received from a passenger.

In step S31, the operation command part 2013 selects a vehicle to be dispatched from among the plurality of autonomous vehicles 300 under the management of the system. This selection is made on the basis of a request for dispatch of a vehicle or other information. For example, the operation command part 2013 may select a vehicle to be dispatched taking into consideration details of the requested service, the present locations of the respective vehicles, and the tasks that the respective vehicles are currently performing. For example, in cases where the requested service is transportation of passengers, the operation command part 2013 selects an autonomous vehicle 300 that has the function of transporting passengers and can reach a designated place within a designated time. For the purpose of this selection, the server apparatus 200 may be configured to hold data relating to the status of each autonomous vehicle 300.

In step S32, the operation command part 2013 creates an operation plan for the autonomous vehicle 300 selected as above. The operation plan is a set of tasks to be fulfilled by the autonomous vehicle 300. Examples of the tasks include travelling to a designated place, picking up or dropping off a passenger, and loading or unloading goods. The tasks also include a route to be travelled by the autonomous vehicle 300. In the system of this embodiment, the operation command part 2013 performs route search to determine a route of travel of the autonomous vehicle 300.

Then in step S33, the operation command part 2013 determines whether or not the created route includes an inappropriate area. If the created route includes an inappropriate area, the process proceeds to step S34. If the created route does not include an inappropriate area, the process proceeds to step S35.

In step S34, the operation command part 2013 re-creates a route keeping out of the inappropriate area and modifies the operation plan with the re-created route.

In step S35, the operation command part 2013 sends the operation plan created as above to the selected autonomous vehicle 300.

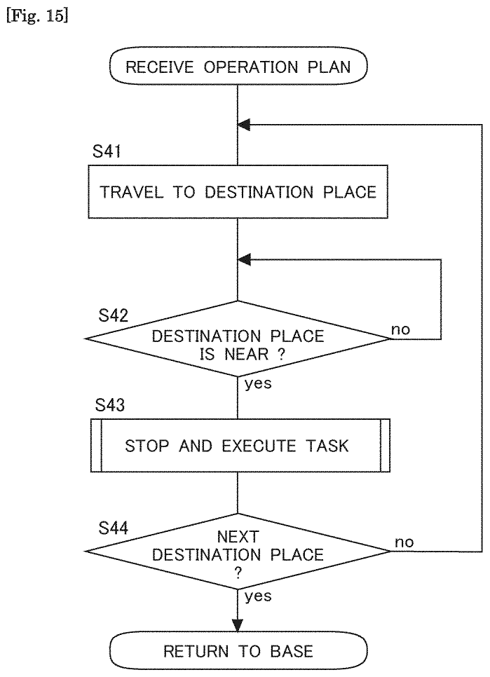

FIG. 15 is a flow chart of a process executed by the autonomous vehicle 300 that receives the operation plan. This process is started when the autonomous vehicle 300 receives the operation plan from the server apparatus 200.

Firstly, in step S41, the autonomous vehicle 300 starts to travel to a destination place (i.e. the place designated by the server 200) along the designated route.

When the autonomous vehicle 300 comes near the destination place (step S42), the autonomous vehicle 300 finds a spot in its neighborhood where it can stop, then stops there, and then executes a task (step S43).

After completing the task, the autonomous vehicle 300 determines whether or not there is a next destination place designated by the operation plan (step S44). If there is a next destination place, the autonomous vehicle 300 continues its operation. If there is not a next destination place, in other words if all the tasks included in the operation plan have been completed, the autonomous vehicle 300 returns to its base.

As described above, the server apparatus 200 according to the first embodiment determines an area (inappropriate area) in which the visibility of lane lines is low on the basis of the vehicle-view moving image sent from the probe cars 10. Thus, the server apparatus 200 can recognize the presence of an inappropriate area on a substantially real-time basis. The server apparatus 200 creates a travel route keeping out of the inappropriate area and gives instructions for operation to an autonomous vehicle 300. In consequence, the autonomous vehicle 300 can avoid troubles that can be caused by difficulty in recognizing lane lines.

### First Modification of First Embodiment

In the system according to the first embodiment, the result of determination performed by the area determination part 2012 is used to create an operation plan for an autonomous vehicle 300. Alternatively, the result of the determination may be used to modify an operation plan for an autonomous vehicle 300 that has already started an operation. For example, when an inappropriate area newly arises, the server apparatus 200 may give to an autonomous vehicle 300 that is planned to pass the inappropriate area instructions to change the route so that the autonomous vehicle 300 will avoid the inappropriate area. When an inappropriate area newly arises, the server apparatus 200 may command an autonomous vehicle 300 that is planned to pass the inappropriate area to suspend or stop the operation. The latter process may be employed in the case where some restriction is imposed on the travel route, for example, in the case where the autonomous vehicle 300 must travel only a predetermined route, as is the case if the autonomous vehicle 300 is a bus on a regular route.

To perform the above process, the server apparatus 200 may store details of operation plans that have been sent to the autonomous vehicles 300.

### Second Modification of First Embodiment

While the server apparatus 200 in the system according to the first embodiment is an apparatus that controls the operation of autonomous vehicles 300, the server apparatus 200 may be an apparatus that performs route search specialized to autonomous vehicles. The server apparatus 200 may be configured to conduct a route search upon request from an autonomous vehicle 300 and return the result of the route search. When responding to a request made by an autonomous vehicle 300, the server apparatus 200 creates a route keeping out of inappropriate areas. When responding to a request from a vehicle that is not an autonomous vehicle, the server apparatus 200 may create a route that includes an inappropriate area.

### Second Embodiment

The system according to the first embodiment is intended to address situations where the visibility of lane lines decrease gradually. However, the visibility of lane lines may change quickly in some cases. For example, the visibility of lane lines may be lowered temporarily due to snow or flood. The visibility of lane lines may also change by repairing of the road.

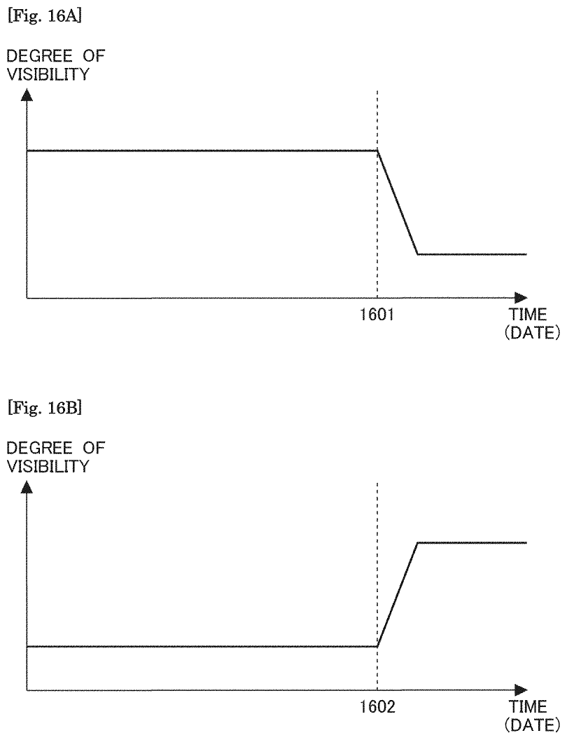

FIG. 16A is a graph illustrating changes in the degree of visibility at a certain place with time. The vertical axis is the value representing the degree of visibility, and the horizontal axis is time (e.g. date). If given data indicates changes like this, it is considered that an event (such as snow or flood) occurred at the time indicated by the numeral “1601”. In this case, data acquired before the time indicated by the numeral “1601” should not be used in calculating the assessment value, because it is considered that the visibility of lane lines is presently very low.

FIG. 16B is a graph illustrating another example of changes in the degree of visibility. If given data indicates changes like this, it is considered that a trouble was resolved (e.g. a flood subsided, or the road was repaired) at the time indicated by the numeral “1602”. In this case data acquired before the time indicated by the numeral “1602” should not be used in calculating the assessment value.

Described in the following as a second embodiment is a system that detects a change in the visibility of lane lines at a rate higher than a predetermined rate (namely, a quick change that occurred recently) and takes an appropriate action.

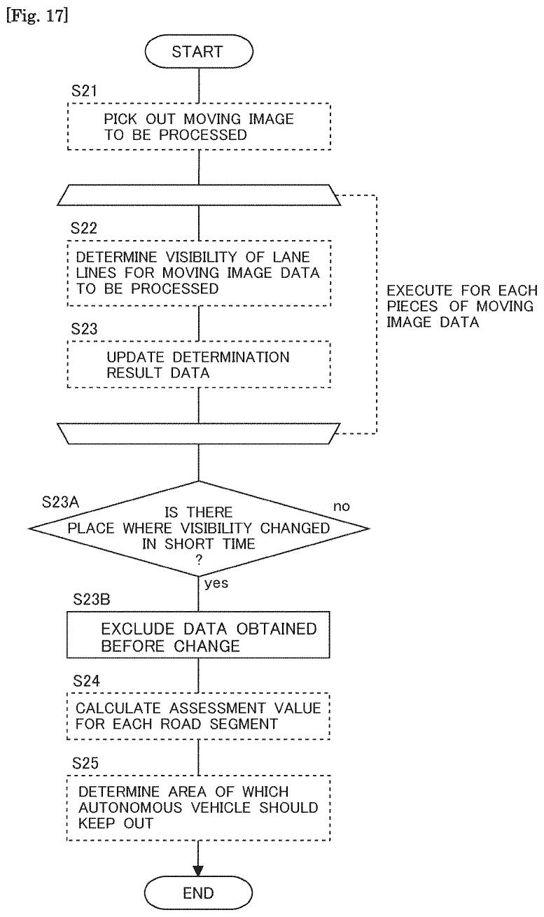

FIG. 17 is a flow chart of a process executed by the server apparatus 200 in the system of the second embodiment. In FIG. 17, the boxes of the steps of processing that are the same as those of the first embodiment are drawn by broken lines and will not be described specifically.

In the process according to the second embodiment, after the determination result data is updated, the processing of step S23A is executed. In step S23A, it is determined whether or not there is a place where the degree of visibility changed in a short time. Specifically, if the degree of visibility changed more than a first threshold (e.g. 20 points) in a period of time shorter than a second threshold (e.g. one day), (e.g. if there was a change of 20 points per day), step S23A is answered in the affirmative.

If step S23A is answered in the affirmative, the process proceeds to step S23B. If step S23A is answered in the negative, the process proceeds to step S24.

In step S23B, it is determined to exclude data acquired at the aforementioned place before the change of the visibility in calculating the degree of visibility. In the cases indicated in FIGS. 16A and 16B, data acquired before the time indicated by the numeral “1601” or “1602” is excluded.

The processing of step S24 onward is the same as that in the first embodiment.

As above, if an event that caused a quick change in the visibility of lane lines occurred, the system according to the second embodiment excludes data acquired before the occurrence of the event in calculating the assessment value. With this feature, even if the visibility of lane lines has been lowered due to weather or other reasons, or if the visibility of lane lines has been restored by repair of the road, it is possible to calculate the assessment value appropriately.

While the system of this embodiment excludes data acquired before the time when the visibility of lane lines changed quickly in calculating the assessment value, the boundary of the time of exclusion is not limited to this, so long as data acquired before the change in the visibility is excluded.

### Other Modifications

The above embodiments have been described only by way of example. The technology disclosed herein can be implemented in modified manners without departing from the essence of this disclosure.

For example, processing and features that have been described in this disclosure may be employed in any combination so long as it is technically feasible to do so.

While the probe cars 10 and autonomous vehicles 300 are used in the systems of the above-described embodiments, the autonomous vehicle 300 may serve as probe cars also.

One or some of the functions performed by the server apparatus 200 may be performed by the on-vehicle apparatus 100 instead. For example, the on-vehicle apparatus 100 may be configured to execute the processing of steps S21 to S23 and send the result of determination to the server apparatus 200. To this end, the map data 202B and the lane line data 202C may be stored in the on-vehicle apparatus 100.

The on-vehicle apparatus 100 may be configured to perform segmentation of obtained images and send the results (e.g. images including labels as indicated in FIG. 5) to the server apparatus 200. Then, the server apparatus 200 may determine the visibility of lane lines on the basis of the images including labels.

This configuration helps to decrease the load on the network.

One or some of the processes that have been described as processes performed by one apparatus may be performed by a plurality of apparatuses in a distributed manner. One or some of the processes that have been described as processes performed by two or more apparatuses may be performed by one apparatus. The hardware configuration (or the server configuration) employed to implement various functions in a computer system may be modified flexibly.

The technology disclosed herein can be implemented by supplying a computer program(s) (i.e. information processing program) that implements the functions described in the above description of the embodiment to a computer to cause one or more processors of the computer to read and execute the program(s). Such a computer program(s) may be supplied to the computer by a computer-readable, non-transitory storage medium that can be connected to a system bus of the computer, or through a network. Examples of the computer-readable, non-transitory storage medium include any type of discs including magnetic discs, such as a floppy disc (registered trademark) and a hard disk drive (HDD), and optical discs, such as a CD-ROM, a DVD, and a Blu-ray disc, a read-only memory (ROM), a random access memory (RAM), an EPROM, an EEPROM, a magnetic card, a flash memory, an optical card, and any type of medium that is suitable for storage of electronic commands.

What is claimed is:

1. An information processing apparatus comprising a controller including at least one processor configured to execute the processing of:
collecting from a plurality of first vehicles first data relating to conditions of lane lines located in the neighborhood of the first vehicles;
determining a first area in which the visibility of the lane lines is equal to or lower than a predetermined value on the basis of the first data; and
executing specific processing for preventing entry of an autonomous vehicle into the first area.

2. The information processing apparatus according to claim 1, wherein the first data includes location information of the first vehicle and a vehicle-view moving image.

3. The information processing apparatus according to claim 1, wherein the first data includes location information of the lane lines detected.

4. The information processing apparatus according to claim 2, wherein the controller determines the visibility of the lane lines by analyzing the vehicle-view moving image.

5. The information processing apparatus according to claim 3, wherein the controller determines the visibility of the lane lines by comparing the locations of the lane lines detected and the locations of lane lines defined in a database.

6. The information processing apparatus according to claim 1, wherein the controller determines changes of the visibility of the lane lines in a specific place with time on the basis of the first data collected at a plurality of points of time.

7. The information processing apparatus according to claim 6, wherein if the rate of change in the visibility of the lane lines in the specific place in relation to the lapse of time is equal to or higher than a predetermined value, the controller excludes the first data collected before a specific point of time in determining the first area.

8. The information processing apparatus according to claim 1, wherein the controller executes the processing of creating a travel route keeping out of the first area for the autonomous vehicle, as the specific processing.

9. The information processing apparatus according to claim 1, wherein the controller executes the processing of stopping the operation of the autonomous vehicle passing the first area, as the specific processing.

10. The information processing apparatus according to claim 1, wherein controller executes the processing of changing the travel route of the autonomous vehicle passing the first area, as the specific processing.

11. An information processing system comprising a server apparatus and a vehicle, wherein
the vehicle comprises a first controller including at least one processor that transmits first data relating to conditions of lane lines located in the neighborhood of the vehicle to the server apparatus, and
the server apparatus comprises a second controller including at least one processor that determines a first area in which the visibility of the lane lines is equal to or lower than a predetermined value on the basis of the first data and executes specific processing for preventing entry of an autonomous vehicle into the first area.

12. The information processing system according to claim 11, wherein the first data includes location information of the vehicle and a vehicle-view moving image.

13. The information processing system according to claim 11, wherein the first data includes location information of the lane lines detected.

14. The information processing system according to claim 12, wherein the second controller determines the visibility of the lane lines by analyzing the vehicle-view moving image.

15. The information processing system according to claim 13, wherein the second controller determines the visibility of the lane lines by comparing the locations of the lane lines detected and the locations of lane lines defined in a database.

16. The information processing system according to claim 11, wherein the second controller determines changes of the visibility of the lane lines in a specific place with time on the basis of the first data collected at a plurality of points of time.

17. The information processing system according to claim 16, wherein if the rate of change in the visibility of the lane lines in the specific place in relation to the lapse of time is equal to or higher than a predetermined value, the second controller excludes the first data collected before a specific point of time in determining the first area.

18. The information processing system according to claim 11, wherein the second controller executes the processing of creating a travel route keeping out of the first area for the autonomous vehicle, as the specific processing.

19. The information processing system according to claim 11, wherein the second controller executes the processing of stopping the operation of the autonomous vehicle passing the first area, as the specific processing.

20. The information processing system according to claim 11, wherein second controller executes the processing of changing the travel route of the autonomous vehicle passing the first area, as the specific processing.
